(19) United States
(12) Patent Application Publication
(10) Pub. No.: US 2024/0320596 A1
(43) Pub. Date: Sep. 26, 2024

(54) SYSTEMS AND METHODS FOR UTILIZING MACHINE LEARNING FOR BURNOUT PREDICTION

(71) Applicant: Optum, Inc., Minnetonka, MN (US)

(72) Inventors: S SHIVARAMAN, Bangalore (IN); Mohammad Kashif Ali KHAN, Phoenix, AZ (US); Abhay SHUKLA, Noida (IN)

(21) Appl. No.: 18/187,101

(22) Filed: Mar. 21, 2023

(51) Int. Cl. G06Q 10/0639; G06Q 10/0631

(52) U.S. Cl. CPC G06Q 10/0639; G06Q 10/06312

(57) ABSTRACT

Systems and methods are disclosed for predicting burnout of an entity. The method includes receiving relevant data associated with the entity from various data sources, the relevant data includes attributes data, professional data, or personal data. A first machine learning model is utilized to determine behavioral persona of the entity based on attributes data. A second machine learning model is utilized to determine professional burnout score for the entity based on professional data and/or a third machine learning model is utilized to determine individual burnout score for the entity based on personal data. A lateral and/or longitudinal burnout risk scores are determined for the entity based on behavioral persona, professional burnout score, and/or individual burnout score. A presentation of a burnout indicator is generated in a user interface of a device upon comparing the lateral and/or longitudinal burnout risk scores with pre-determined burnout threshold.

### TECHNICAL FIELD

The present disclosure relates generally to data collection, data processing, and data analysis, and more particularly, to systems and methods for utilizing machine learning for prediction and prevention of burnout of an entity.

### BACKGROUND

Burnout among entities, such as professional entities, is an acknowledged crisis in the healthcare system. Burnout is difficult to detect because it is a state of emotional, physical, and mental exhaustion experienced on an individual level and caused by a multitude of different variables, e.g., work-related stress and activity, individual lifestyle, and personality traits. Burnout reduces the quality of care provided by professional entities, e.g., studies have shown that surgeons experiencing burnout make more medical errors. Burnout negatively impacts the productivity of professional entities, e.g., studies have shown that physicians experiencing burnout are less productive. Burnout also diminishes patient satisfaction, e.g., studies have shown a decrease in satisfaction among patients examined by physicians experiencing burnout. Burnout has proven to be the highest cause for increased physician turnover, causing lulls in productivity while searches are conducted to find replacement physicians.

At present, conventional methods for detecting burnout are based on limited information derived from measuring physical conditions associated with professional entities and do not take into consideration the psychological, sociological, and working environment of the professional entities. The current burnout detection methods commonly use surveys that are often unreliably taken and/or taken at a time convenient for the professional entity, such surveys detect burnout at a specific point in time, i.e., during the surveys, and actions from the surveys are often delayed because the survey data is lagging. Service providers, e.g., healthcare service providers, are technically challenged to detect, in real-time, professional entities experiencing burnout, and also experience difficulty in preventatively mitigating the burnout before it is too late.

Unless otherwise indicated herein, the materials described in this section are not prior art to the claims in this application and are not admitted to be prior art, or suggestions of the prior art, by inclusion in this section.

### SUMMARY

The present disclosure solves this problem and/or other problems described above or elsewhere in the present disclosure and improves the state of conventional healthcare applications. The present disclosure teaches systems and methods for detecting burnout in real-time and/or predicting burnout for professional entities using machine learning. In some embodiments, the present disclosure generates behavioral persona of the professional entities by utilizing data from a plurality of data sources, predicts their professional burnout scores and/or individual burnout scores, and generates lateral and longitudinal burnout risk scores to predict burnout. The methods and system also generate a presentation of a burnout indicator in a user interface of a device upon determining the lateral and/or longitudinal burnout risk scores exceed a pre-determined burnout threshold.

In some embodiments, a computer-implemented method for predicting a burnout of an entity is disclosed. The computer-implemented method includes receiving, by one or more processors, relevant data associated with the entity from a plurality of data sources, wherein the relevant data includes attributes data and at least one of professional data or personal data; determining, by the one or more processors and using a first machine learning model, a behavioral persona of the entity based on the attributes data; determining, by the one or more processors and using at least one of a second machine learning model or a third machine learning model, at least one of a professional burnout score for the entity based on the professional data or an individual burnout score for the entity based on the personal data, respectively; determining, by the one or more processors, at least one of a lateral burnout risk score or a longitudinal burnout risk score for the entity based on at least one of the behavioral persona, the professional burnout score, or the individual burnout score; comparing, by the one or more processors, at least one of the lateral burnout risk score or the longitudinal burnout risk score with a pre-determined burnout threshold; and causing, by the one or more processors, a presentation of a burnout indicator to be displayed in a user interface of a device based upon the comparing.

In some embodiments, a system for predicting a burnout of an entity is disclosed. The system includes one or more processors; and at least one non-transitory computer readable medium storing instructions which, when executed by the one or more processors, cause the one or more processors to perform operations including: receiving relevant data associated with the entity from a plurality of data sources, wherein the relevant data includes attributes data and at least one of professional data or personal data; determining, using a first machine learning model, a behavioral persona of the entity based on the attributes data; determining, using at least one of a second machine learning model or a third machine learning model, at least one of a professional burnout score for the entity based on the professional data or an individual burnout score for the entity based on the personal data, respectively; determining at least one of a lateral burnout risk score or a longitudinal burnout risk score for the entity based on at least one of the behavioral persona, the professional burnout score, or the individual burnout score; comparing at least one of the lateral burnout risk score or the longitudinal burnout risk score with a pre-determined burnout threshold; and causing a presentation of a burnout indicator to be displayed in a user interface of a device based upon the comparing.

In some embodiments, a non-transitory computer readable medium for predicting a burnout of an entity is disclosed. The non-transitory computer readable medium stores instructions which, when executed by one or more processors, cause the one or more processors to perform operations including: receiving relevant data associated with the entity from a plurality of data sources, wherein the relevant data includes attributes data and at least one of professional data or personal data; determining, using a first machine learning model, a behavioral persona of the entity based on the attributes data; determining, using at least one of a second machine learning model or a third machine learning model, at least one of a professional burnout score for the entity based on the professional data or an individual burnout score for the entity based on the personal data, respectively; determining at least one of a lateral burnout risk score or a longitudinal burnout risk score for the entity based on at least one of the behavioral persona, the professional burnout score, or the individual burnout score; comparing at least one of the lateral burnout risk score or the longitudinal burnout risk score with a pre-determined burnout threshold; and causing a presentation of a burnout indicator to be displayed in a user interface of a device based upon the comparing.

It is to be understood that both the foregoing general description and the following detailed description are example and explanatory only and are not restrictive of the detailed embodiments, as claimed.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1 is a diagram showing an example of a system that is capable of predicting a burnout of a professional entity, according to some embodiments of the disclosure.

FIG. 2A is a diagram of example components of a burnout prediction platform, according to some embodiments of the disclosure.

FIG. 2B is a diagram of example components of a machine learning module, according to some embodiments of the disclosure.

FIG. 3 is a flowchart of an example of a process for predicting a burnout of a professional entity, according to some embodiments of the disclosure.

FIG. 4 is a diagram showing an example of a process for clustering similar features from a data set to generate behavioral personas of professional entities, according to some embodiments of the disclosure.

FIG. 5 is a diagram that illustrates the clustering of unlabeled data to generate behavioral personas of professional entities, according to some embodiments of the disclosure.

FIG. 6 is a diagram showing an example of a process for generating professional burnout scores and individual burnout scores for professional entities, according to some embodiments of the disclosure.

FIG. 7 is a diagram showing an example of a decision tree depicting a machine learning and artificial intelligence (AI) engine determining burnout among professional entities, according to some embodiments of the disclosure.

FIG. 8 is a diagram that illustrates an example process for calculating lateral burnout risk score and longitudinal burnout risk score for determining intervention, according to some embodiments of the disclosure.

FIG. 9 shows an example machine learning training flow chart, according to some embodiments of the disclosure.

FIG. 10 illustrates an implementation of a computer system that executes techniques presented herein, according to some embodiments of the disclosure.

### DETAILED DESCRIPTION

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

Various non-limiting embodiments of the present disclosure will now be described to provide an overall understanding of the principles of the structure, function, and use of systems and methods disclosed herein for predicting burnout among professional entities.

Burnout negatively impacts the quality of care, the total cost of care, patient satisfaction, the productivity of an entity (e.g., healthcare professional), and retention of the entity which are core to care delivery. Studies have shown that physicians experiencing burnout have experienced emotional exhaustion and depersonalization, and any type of pandemic intensifies their sense of burnout. Studies have also shown that physicians who do not have adequate time for electronic health record (EHR) documentation are more likely to show symptoms of burnout, e.g., physicians who spend moderately high or excessive amounts of time on EHR documentation at home are more likely to show burnout symptoms than those who spend minimal or no time on EHR documentation at home. Physicians who agreed that EHR documentation adds to the frustration of the day are more likely to show burnout symptoms than those who disagreed.

Organizations commonly use surveys to understand burnout associated with the professional entity. However, surveys have several drawbacks, such as (i) surveys adoption is not universal, e.g., a response rate of about 66% on the surveys indicates that the service providers are uninformed about the burnout and experience of ⅓^{rd} of the professional entities, (ii) surveys detect burnout at a specific point of time rather than in real-time, e.g., service providers are only aware of the burnout experienced by the professional entities at the point of time of the survey and are uninformed between surveys, and (iii) actions from surveys are delayed because the survey data is lagging, e.g., professional entities may have been experiencing burnout from January to June, the survey is conducted in June when the burnout is detected, the survey data collection occurs throughout June for analysis in July, and action is taken in August. Furthermore, even if burnout is detected in a survey, service providers do not understand the root cause of burnout for individual professional entities which leads to interventions that are not properly targeted.

Studies have found correlations between certain aspects of professional entities' work and personal environment and burnout, but the existing solutions neither detect the risk of professional entities' burnout nor predict the future risk of professional entities' burnout. For example, a known rudimentary tool within electronic medical records (EMR) called ‘signal’ collects and reports EMR data in a dashboard, but does not use task data to detect the risk of burnout, predict the risk of future burnout, suggest targeted interventions, or track intervention performance. Currently, there are no standardized or widely accepted metrics of burnout, and burnout is mainly identified through surveys that do not happen regularly, leaving a big gap between surveys. There is a lack of advanced data-based mechanisms to detect burnout, especially during a shortage of professional entities.

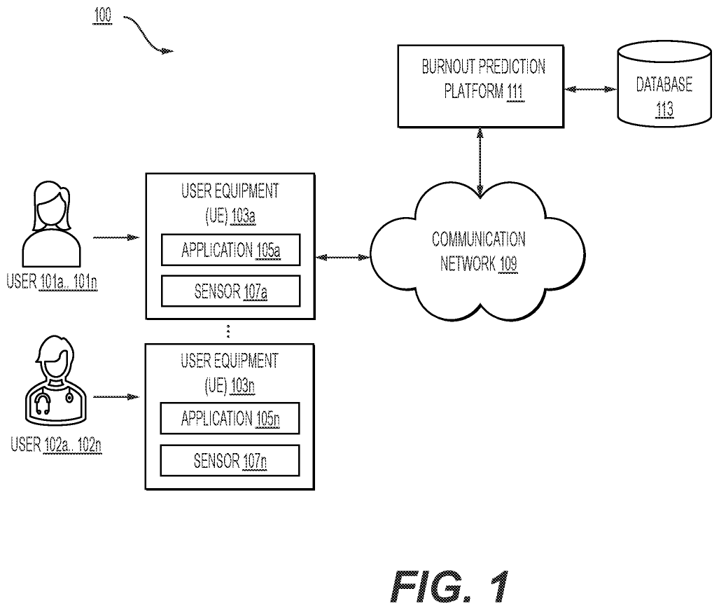

To address these challenges, a system 100 of FIG. 1 introduces the capability to predict burnout by utilizing a machine learning model that proactively identifies professional entities who are likely to experience burnout based, at least in part, on their behavioral persona, professional burnout score, and/or individual burnout score. The system 100 views burnout at professional and individual levels for each professional entity based on their area of specialty and measures the professional entity against their longitudinal and lateral scores. In one example embodiment, the claimed invention predicts burnout among cardiovascular surgeons, e.g., surgeon A is experiencing professional burnout due to work pressure but personally he is doing fine; surgeon B is experiencing both professional and personal burnout; surgeon C is not experiencing any burnout and is doing fine both professionally and personally; and surgeon D is experiencing personal burnout but professionally he is doing fine. The system 100 generates targeted interventions for surgeon A, B, and D.

FIG. 1 introduces a capability to implement modern communication and data processing capabilities into methods and systems for burnout prediction. FIG. 1, an example architecture of one or more example embodiments of the present invention, includes a system 100 that comprises users 101a-101n (collectively referred to as a user 101), users 102a-102n (collectively referred to as a user 102), user equipment (UE) 103a-103n (collectively referred to as UE 103) that includes applications 105a-105n (collectively referred to as an application 105) and sensors 107a-107n (collectively referred to as a sensor 107), a communication network 109, a burnout prediction platform 111, and a database 113.

In one embodiment, the user 101 is a person or a group of people interacting with a user interface or a web interface of the UE 103 to access a service, e.g., healthcare service(s). In one embodiment, the user 101 includes a registered patient, a potential patient, a returning patient, a visiting patient, and/or any other authorized user of the service that provides contextual information relating to the professional entity. In one example embodiment, the user 101 shares experience scores and/or satisfaction scores on being examined by professional entities experiencing burnout compared to professional entities not experiencing burnout. The experience scores and/or satisfaction scores are collected via online surveys and/or through various data collection mechanisms that collects data from a plurality of data sources (e.g., the database 113, medical records databases, a regulation database, e.g., state or federal managed databases, and/or any third-party databases). In another example embodiment, the user 101 shares general health-related information, e.g., blood pressure, body temperature, heart rate, etc., specialized health indicators, e.g., lab data, blood indicators, physiological data, etc., and/or any other relevant information that assists system 100 in categorizing the user 101 as a high-risk patient, medium-risk patient, or low-risk patient. Such categorization of the user 101 assists the system 100 in determining burnout among professional entities.

In one embodiment, the user 102 is a professional entity, e.g., primary care physician, specialty physician, general surgeon, specialty surgeon, clinician, medical resident, medical practitioner, nurses, etc., providing medical-related services to the user 101. In another embodiment, the user 102 includes any working professionals in a stressful environment who are likely to experience burnout, e.g., attorneys, engineers, accountants, teachers, drivers, construction workers, social workers, firefighters, managers, and so on. In one example embodiment, the user 102 shares health-related information, e.g., stress level, blood pressure level, body temperature, etc., work-related information (e.g., patient volume, patient complexity, amount of documentation, staffing ratio, etc.), lifestyle data (e.g., eating patterns, drinking patterns, sleeping patterns, exercise patterns, smoking patterns, etc.), and/or personal information (e.g., environmental data, family-related issues, etc.) that assists system 100 in determining burnout among professional entities. The health-related information, work-related information, lifestyle data, and personal information are collected via online surveys and/or through various data collection mechanisms that collect data from a plurality of data sources, e.g., the database 113, medical records databases, a regulation database, e.g., state or federal managed databases, and/or any third-party databases.

In one embodiment, the UE 103 includes, but is not restricted to, any type of mobile terminal, wireless terminal, fixed terminal, or portable terminal. Examples of the UE 103, include, but are not restricted to, a mobile handset, a wireless communication device, a station, a unit, a device, a multimedia computer, a multimedia tablet, an Internet node, a communicator, a desktop computer, a laptop computer, a notebook computer, a netbook computer, a tablet computer, a Personal Communication System (PCS) device, a personal navigation device, a Personal Digital Assistant (PDA), a digital camera/camcorder, an infotainment system, a dashboard computer, a television device, or any combination thereof, including the accessories and peripherals of these devices, or any combination thereof. In addition, the UE 103 facilitates various input means for receiving and generating information, including, but not restricted to, a touch screen capability, a keyboard, and keypad data entry, a voice-based input mechanism, and the like. Any known and future implementations of the UE 103 are also applicable.

In one embodiment, the applications 105 includes various applications such as, but not restricted to, content provisioning applications, software applications, networking applications, multimedia applications, media player applications, camera/imaging applications, application services, storage services, contextual information determination services, location-based services, notification services, social networking services, and the like. In one embodiment, one of the applications 105 at the UE 103 acts as a client for the burnout prediction platform 111 and performs one or more functions associated with the functions of the burnout prediction platform 111 by interacting with the burnout prediction platform 111 over the communication network 109.

By way of example, each sensor 107 includes any type of sensor. In one embodiment, the sensors 107 include, for example, a network detection sensor for detecting wireless signals or receivers for different short-range communications (e.g., Bluetooth, Wi-Fi, Li-Fi, near field communication (NFC), etc.), a global positioning sensor for gathering location data, a camera/imaging sensor for gathering image data, an audio recorder for gathering audio data, and the like. In another embodiment, the sensors 107 include, for example, inertial measurement unit (IMU) sensors, electrocardiogram (ECG) sensors, sensors to detect blood glucose level, sensors to measure respiration rate, heart rate detection sensors, sensors to monitor body temperature, micro-electro-mechanical system (MEMS) based miniature motion sensors, gyroscope, accelerometer, magnetometer, infrared sensor, microphone, gas sensor, etc. In one example embodiment, the sensors 107 are provided in wearable devices (e.g., watches, internet of things devices, smart clothing, etc.) and/or any health monitoring devices, that capture and analyzes health data (e.g., activity data, vitals data, stress level, heart rate, blood pressure, oxygen saturation level, ECG, etc.), and any other data indicative of health condition (e.g., eating/drinking patterns, exercise regime, medication intake, age, weight, gender, etc.) of the user 102 in real-time.

In one embodiment, various elements of the system 100 communicate with each other through the communication network 109. The communication network 109 supports a variety of different communication protocols and communication techniques. In one embodiment, the communication network 109 allows the burnout prediction platform 111 to communicate with the UE 103. The communication network 109 of the system 100 includes one or more networks such as a data network, a wireless network, a telephony network, or any combination thereof. It is contemplated that the data network is any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network is, for example, a cellular communication network and employs various technologies including 5G (5th Generation), 4G, 3G, 2G, Long Term Evolution (LTE), wireless fidelity (Wi-Fi), Bluetooth®, Internet Protocol (IP) data casting, satellite, mobile ad-hoc network (MANET), vehicle controller area network (CAN bus), and the like, or any combination thereof.

In one embodiment, the burnout prediction platform 111 is a platform with multiple interconnected components. The burnout prediction platform 111 includes one or more servers, intelligent networking devices, computing devices, components, and corresponding software for predicting burnout among professional entities. In addition, it is noted that the burnout prediction platform 111 may be a separate entity of the system 100.

In one embodiment, the burnout prediction platform 111 receives relevant data associated with the user 102 from various data sources. The burnout prediction platform 111 utilizes a first machine learning model 211 to determine the behavioral persona of the user 102 based on attributes data. The burnout prediction platform 111 utilizes a second machine learning model 214 to determine a professional burnout score for the user 102 based on professional data. The burnout prediction platform 111 utilizes a third machine learning model 224 to determine individual burnout scores for the user 102 based on personal data. The burnout prediction platform 111 then determines a lateral burnout risk score and/or a longitudinal burnout risk score for the user 102 based on the behavioral persona, the professional burnout score, and/or individual burnout score. The burnout prediction platform 111 generates a presentation of a user interface element, e.g., a burnout indicator, in a user interface of the UE 103 upon determining the lateral and/or longitudinal burnout risk scores exceed the pre-determined burnout threshold.

In one embodiment, the burnout prediction platform 111 modifies the work schedule of the user 102 based on the burnout indicator. In another embodiment, the burnout prediction platform 111 generates an intervention notification based on the burnout indicator. The intervention notification is transmitted to the UE 103 associated with an intervention entity, e.g., medical directors, supervisors, or any other professionals overseeing the workload of the user 102 and assisting in the intervention. In a further embodiment, the burnout prediction platform 111 analyzes the lateral burnout risk score and/or the longitudinal burnout risk score to measure intervention efficacy and/or intervention adherence. Further details of the burnout prediction platform 111 are provided below.

In one embodiment, the database 113 is any type of database, such as relational, hierarchical, object-oriented, and/or the like, wherein data are organized in any suitable manner, including data tables or lookup tables. In one embodiment, the database 113 accesses or includes any suitable data that may be utilized to predict burnout. In one embodiment, the database 113 stores content associated with the user 101, the user 102, the UE 103, and the burnout prediction platform 111 and manages multiple types of information that provide means for aiding in the content provisioning and sharing process. The database 113 includes various information related to the user 102 including health-related information, e.g., stress level, blood pressure level, body temperature, etc., work-related information, e.g., patient volume, patient complexity, amount of documentation, staffing ratio, etc., lifestyle data, e.g., eating patterns, drinking patterns, sleeping patterns, exercise patterns, smoking patterns, etc., personal information, e.g., environmental data, family-related information, etc. It is understood that any other suitable data may be included in the database 113.

In one embodiment, the database 113 includes a machine-learning based training database with a pre-defined mapping defining a relationship between various input parameters and output parameters based on various statistical methods. For example, the training database includes machine-learning algorithms to learn mappings between input parameters related to the user 102, e.g., health-related information, work-related information, lifestyle data, and personal information. In one embodiment, the training database includes a dataset that includes data collections that are not subject-specific, e.g., data collections based on population-wide observations, local, regional or super-regional observations, burnout-based observations, and the like. Example datasets include demographic data, burnout data, medical error data, patient satisfaction data, turnover data, encyclopedias, scientific and medical-related periodicals and journals, research studies data, nutritional data, exercise data, physician and hospital/clinic location information, and the like. In an embodiment, the training database is routinely updated and/or supplemented based on machine learning methods.

By way of example, the UE 103 and the burnout prediction platform 111 communicate with each other and other components of the communication network 109 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

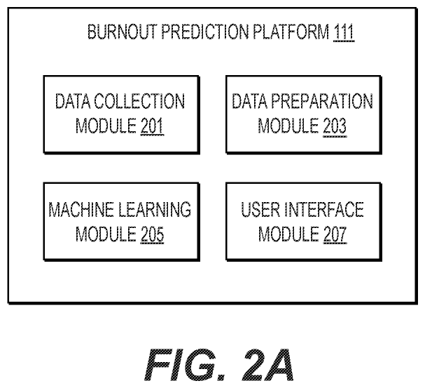

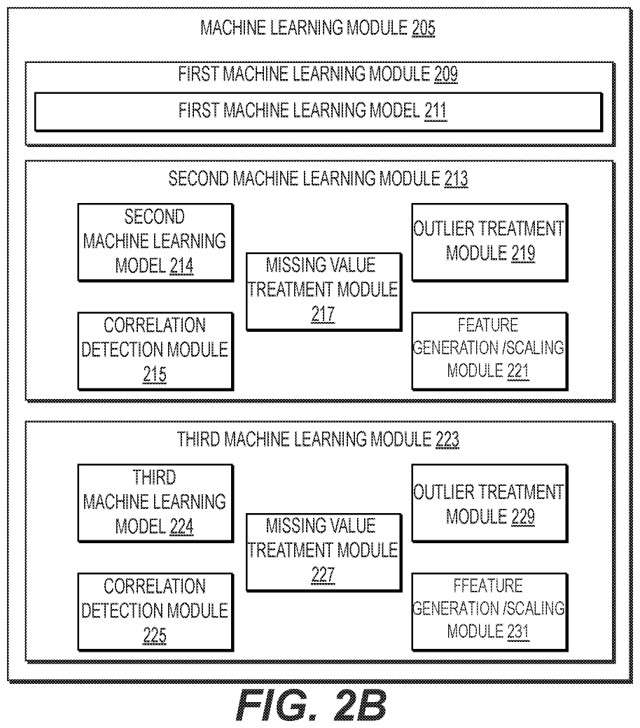

FIG. 2A is a diagram of the components of the burnout prediction platform 111, according to some aspects of the disclosure. As used herein, terms such as “component” or “module” generally encompass hardware and/or software, e.g., that a processor or the like is used to implement associated functionality. By way of example, the burnout prediction platform 111 includes one or more components for predicting and/or detecting burnout. It is contemplated that the functions of these components are combined in one or more components or performed by other components of equivalent functionality. In one embodiment, the burnout prediction platform 111 comprises a data collection module 201, a data preparation module 203, a machine learning module 205, and a user interface module 207, or any combination thereof.

In one embodiment, the data collection module 201 collects relevant data, e.g., health-related information, work-related information, personal information, lifestyle data, etc., associated with the user 102 through various data collection techniques. In one embodiment, the data collection module 201 uses a web-crawling component to access various databases, e.g., the database 113, or other information sources, e.g., any third-party databases, to collect relevant data associated with the user 102. In one embodiment, the data collection module 201 includes various software applications, e.g., data mining applications in Extended Meta Language (XML), that automatically search for and return relevant data regarding the user 102. In one example embodiment, the data collection module 201 collects health data associated with the user 102 via a variety of the UE 103, e.g., monitoring devices that measures the physiological parameters, e.g., stress level, heart rate, blood oxygen saturation levels, respiratory rate, blood pressure, weight, etc., of the user 102. For example, the UE 103 includes a smartwatch, a smart wristband, a smartphone, smart clothing, or other devices including the sensors 107, e.g., an electrocardiogram (ECG) sensor, optical Heart Rate (PPG) sensor, blood pressure sensors, physiological sensors, any health-related sensors, location sensors, a gyroscope, an accelerometer, a magnetometer, a camera, a microphone, etc., capable of capturing activity data and vital data of the user 102. In one embodiment, these monitoring devices are equipped with operating systems like Android™, iOS™, Windows®, Linux™ OS, or hybrid frameworks that enable efficient integration. In one example embodiment, the collection of relevant data is automated, e.g., an automatic human activity recognition technique that captures data from wearable and/or non-wearable monitoring devices. The human activity recognition technique is used to build Human Activity Recognition (HAR) datasets. In one embodiment, the burnout prediction platform 111 provides weightage to health vitals that are relevant to the underlying health conditions of the professional entity and compares with industry and individual baseline.

In one embodiment, the data preparation module 203 parses and arranges the data collected by the data collection module 201. In one example embodiment, the data preparation module 203 examines the collected data for any errors to eliminate bad data, e.g., redundant, incomplete, or incorrect data, to create high-quality data. In one example embodiment, collected data, e.g., raw data, is converted into a common format, e.g., machine readable form, that is easily processed by other modules and platforms. The data is then subjected to various data processing methods using machine learning and artificial intelligence algorithms to generate a desired output.

In one embodiment, the machine learning module 205 is configured for unsupervised machine learning (e.g., the first machine learning model 211) that does not require training using known outcomes 918. The unsupervised machine learning utilizes machine learning algorithms to analyze and cluster unlabeled datasets and discover hidden patterns or data groupings, e.g., similarities and differences within data, without supervision. In one example embodiment, the unsupervised machine learning implements approaches that includes clustering (e.g., deep embedded clustering, K-means clustering, hierarchical clustering, probabilistic clustering), association rules, classification, principal component analysis (PCA), or the like. The machine learning module 205 utilizes the unsupervised machine learning techniques to identify behavioral persona of the user 102.

In one embodiment, the machine learning module 205 is also configured for supervised machine learning (e.g., the second machine learning model 214 and/or the third machine learning model 224) that utilizes training data, e.g., training data 912 illustrated in the training flow chart 900, for training a machine learning model configured to predict and/or detect burnout based on the relevant data associated with the user 102. In one example embodiment, the machine learning module 205 performs model training using training data, e.g., data from other modules, that contains input and correct output, to allow the model to learn over time. The training is performed based on the deviation of a processed result from a documented result when the inputs are fed into the machine learning model, e.g., an algorithm measures its accuracy through the loss function, adjusting until the error has been sufficiently minimized. In one embodiment, the machine learning module 205 randomizes the ordering of the training data, visualizes the training data to identify relevant relationships between different variables, identifies any data imbalances, and splits the training data into two parts where one part is for training a model and the other part is for validating the trained model, de-duplicating, normalizing, correcting errors in the training data, and so on. The machine learning module 205 implements various machine learning techniques, e.g., K-nearest neighbors, cox proportional hazards model, decision tree learning, association rule learning, neural network (e.g., recurrent neural networks, graph convolutional neural networks, deep neural networks), inductive programming logic, support vector machines, Bayesian models, Gradient boosted machines (GBM), LightGBM (LGBM), Xtra tree classifier, etc.

In one embodiment, the machine learning module 205 implements natural language processing (NLP) to analyze, understand, and derive meaning from the texts written by the users 102, e.g., documentation, physician's notes. NLP is applied to analyze text, allowing machines to understand how humans speak/write, enabling real-world applications such as automatic text summarization, sentiment analysis, topic extraction, named entity recognition, parts-of-speech/text tagging, relationship extraction, stemming, and/or the like. In one embodiment, NLP generally encompasses techniques including, but not limited to, keyword search, finding relationships (e.g., synonyms, hypernyms, hyponyms, and meronyms), extracting information (e.g., keywords, key phrases, search terms), classifying, and determining positive/negative sentiment of documents. In one example embodiment, the machine learning module 205 utilizes NLP to perform sentiment analysis on a physician's comments and/or feedback in the EMR to determine whether the physician is using strong language and the sentences are getting progressively smaller or whether they are comfortably writing longer sentences that are polite and properly punctuated.

In one embodiment, the user interface module 207 enables a presentation of a graphical user interface (GUI) in the UE 103 that facilitates burnout notification and visualization. The user interface module 207 employs various application programming interfaces (APIs) or other function calls corresponding to the application 105 on the UE 103, thus enabling the display of graphics primitives such as icons, bar graphs, menus, buttons, data entry fields, etc. In another embodiment, the user interface module 207 causes interfacing of guidance information to include, at least in part, one or more annotations, audio messages, video messages, or a combination thereof pertaining to the burnout notification. In another example embodiment, the user interface module 207 operates in connection with augmented reality (AR) processing techniques, wherein various applications, graphic elements, and features interact to present burnout notifications in a format that is understandable by the recipients, e.g., service providers.

The above presented modules and components of the burnout prediction platform 111 are implemented in hardware, firmware, software, or a combination thereof. Though depicted as a separate entity in FIG. 2A, it is contemplated that the burnout prediction platform 111 is also implemented for direct operation by the respective UE 103. As such, the burnout prediction platform 111 generates direct signal inputs by way of the operating system of the UE 103. In another embodiment, one or more of the modules 201-207 are implemented for operation by the respective UEs, as the burnout prediction platform 111. The various executions presented herein contemplate any and all arrangements and models.

FIG. 2B is a diagram of the components of the machine learning module 205, according to some aspects of the disclosure. In one embodiment, the machine learning module 205 comprises the first machine learning module 209, the second machine learning module 213, and the third machine learning module 223 for predicting burnout.

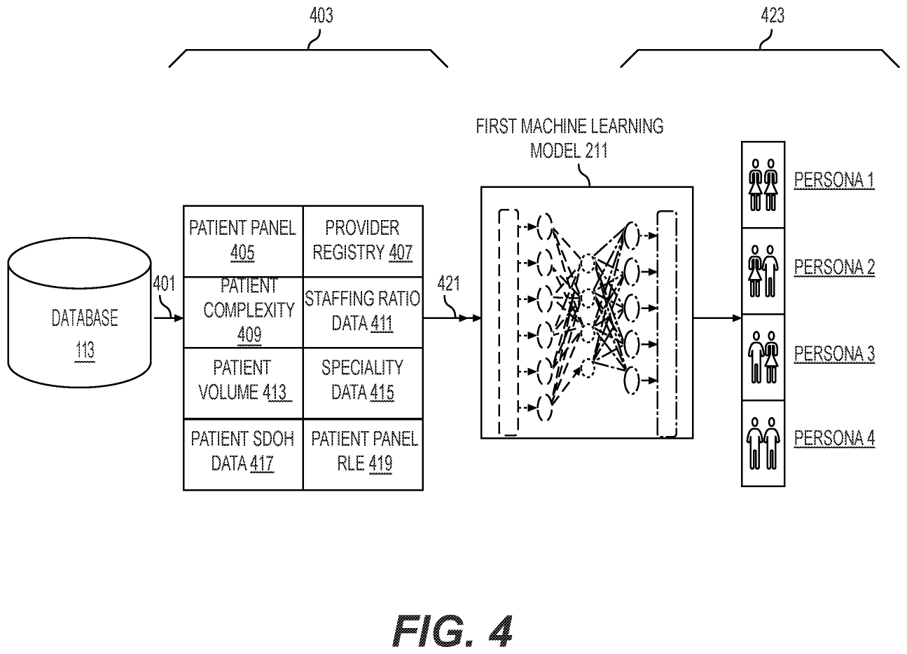

In one embodiment, the first machine learning module 209 includes a first machine learning model 211, which is an unsupervised machine learning model for determining behavioral persona of the user 102. The first machine learning model 211 is a clustering model that identifies and groups similar data points, e.g., collecting unlabeled and uncategorized data into groups based on their similarity. In one embodiment, the first machine learning model 211 utilizes various clustering methods, including but not limited to K-means, deep embedded clustering, hierarchical clustering, density-based spatial clustering of applications with noise (DBSCAN), Gaussian Mixtures Model (GMM), etc. In one example embodiment, the clustering model selects various clustering features from the database 113, and these features (depicted in FIG. 4) include:
(i) Patient panel, e.g., a patient panel 405: This data set includes the number of patients, the complexity of patients of each provider. The size and the complexity of the panel are compared to other providers in the same practice to determine whether a particular physician is overburdened.
(ii) Provider registry, e.g., a provider registry 407: This data set includes demographic data (e.g., age information, gender information, location information, income level, education level, household data, ethnic origin, marital status, children data, languages spoken, etc.) and professional information (e.g., name, identifiers, area of expertise, contact information, licensing status, etc.) associated with the user 102.
(iii) Patient complexity, e.g., a patient complexity 409: This data set includes information on the standard care and decision-making by symptom severity or impairments, diagnostic uncertainty, difficulty engaging care, lack of social safety or participation, disorganization of care, or difficult patient-physician relationships. In one embodiment, patient complexity data can be derived from the international classification of diseases, tenth revision (ICD 10) codes in the continuity of care document (CCD) data or collected in the EMR task data.
(iv) Staffing ratio data, e.g., a staffing ratio data 411: This data set includes the number of healthcare staff, e.g., receptionists, nurses, etc., available per professional entity for performing administrate work. The number of administrative staff has an enormous impact on physicians' workload, for example, if a clinic does not have enough administrative staff the physician ends up performing the administrative work which leads to burnout.
(v) Patient volume, e.g., a patient volume 413: This data set indicates any variations, e.g., increases or decreases, in the number of patients visiting a specific professional entity. A patient volume can be used as a signal for monitoring burnout among the user 102, e.g., a sudden increase of patients or conversely a sudden decrease in the number of patients could be a strong signal for burnout. Patient volume variations result from numerous factors, e.g., a natural disaster, pandemic, provider leaving the practice or a competitor opening another facility to provide similar services, etc.
(vi) Specialty data, e.g., a specialty data 415: Burnout does not impact all specialties uniformly, hence this data set includes the area of specialty of the user 102. For example, neurologists and primary care physicians have the highest burnout rates while plastic reconstruction surgeons have the lowest level of burnout.
(vii) Patient social determinants of health (SDOH) data, e.g., a patient SDOH data 417: This data set indicates non-medical factors that influence health outcomes. For example, SDOH data includes (i) the conditions in which the patients are born, grow, and live (e.g., housing, transportation, neighborhood safety, access to clean air and water, etc.), (ii) racism, discrimination, and violence (e.g., education, job opportunities, income, etc.), (iii) nutrition and health (e.g., access to nutritious food after the appointment(s) or surgery, access to gym/recreational facilities, etc.). While physicians are encouraged to gather SDOH data from patients, most are unable due to time constraints and the inability to offer assistance to the patient due to a lack of resources. Their inability to help patients facing food insecurity, domestic violence, or incapability of affording medication takes a toll on the ability of the user 102 to make an impact on the community or the patient.
(viii) Race, language, and ethnicity (RLE) of the patient, e.g., a patient panel RLE 419: This data set provides information on the race, language, and ethnicity of the user 101. For example, the user 102 are negatively impacted if they cannot speak the language of their patients. Since patients cannot understand their physicians, the quality-of-care drops leading to personalized exertion, and the physicians are penalized for poor outcomes by the Centers for Medicare & Medicaid (CMS) services. For example, the race and gender of the patients also play an integral role because some patients do not want to discuss certain issues with the opposite gender.
(ix) Other data sets: The data sets include various types of information pertaining to the user 102, e.g., paid-time-off (PTO) usage, revenue models used, heart rate data, voice recognition analytics, claims data, financial investment data, financial outlook data, social media usage, past training completed, engagement within the organization, etc. The data sets also include EMR task data comprising task data fields with time stamps for task generation, completion, and other data values. The number of delayed tasks has a high correlation to burnout among professional entities. The data sets also include EMR time of use, e.g., time spent at home charting to document is considered a part of the professional burnout score. The data sets also include net promoter score (NPS), an index that measures the willingness of the patients to recommend the physicians.

In one embodiment, the second machine learning module 213 includes a second machine learning model 214, which is a supervised machine learning model for determining a professional burnout score for the user 102 based on professional data associated with the user 102. The professional burnout score is determined using a suitable supervised machine learning technique such as, e.g., GBM, LGMB, Xtra tree classifier, and the like. The second machine learning model 214 is supported by a correlation detection module 215, a missing value treatment module 217, an outlier treatment module 219, and a feature generation/scaling module 221 during the pre-processing and feature engineering stages, to form a master data set that gets fed into the second machine learning model 214.

In one embodiment, the correlation detection module 215 processes the data received from the data preparation module 203 for a statistical measure of the relationship between two or more variables. In one embodiment, the correlation detection module 215 determines a degree of relationship between two or more variables based upon changes in one variable in relation to the other variables. If two variables are closely correlated, then one variable can be predicted from the other, e.g., the correlation detection module 215 determines seven attributes are correlated and provides the same information, hence instead of using all seven attributes, any one of these attributes may be utilized. In one example embodiment, two variables are positively correlated when the value of one variable increases with an increase in the value of the other variable(s). In another example embodiment, two variables are negatively correlated when the value of one variable increases with a decrease in the value of the other variable(s).

The problem of missing values is common in datasets and these values can bias the results of the machine learning models and reduce the accuracy of the model. In one embodiment, the missing value treatment module 217 identifies the missing values in datasets (e.g., missing completely at random (MCAR), missing at random (MAR), missing not at random (MNAR)), and ascertains the reasons for the missing data (e.g., corrupted past data, failure in recording data due to human error, etc.). The missing value treatment module 217 develops a strategy to handle the missing values, e.g., imputing missing values for a continuous variable, imputing missing values for a categorical variable, using algorithms that support missing values, prediction of missing values, imputation using deep learning library, or any other imputation methods. In one example embodiment, the missing value treatment module 217 identifies the missing value of the attribute in the dataset varies from 5% to 50%. The missing value treatment module 217 determines whether to input the dataset having up to 50% missing values to the machine learning models.

The performance of any machine learning model depends on the data it is trained on, and it can be influenced by changing the distribution or adding outliers in the input data. Outliers can lead machine learning models to less accuracy and larger training time, hence the outlier treatment module 219 handles the outliers before providing the data for training. Outliers are different values, e.g., abnormally low or abnormally high, and their presence often skews the results of statistical analyses on the dataset. In one example embodiment, the outliers include global outliers (e.g., a data point whose value is far outside the entirety of the dataset), contextual outliers (e.g., an individual data instance is anomalous in a specific context), or collective outliers (e.g., a collection of data points is anomalous concerning the entire data set). In one embodiment, the outlier treatment module 219 utilizes various calculations (e.g., standard deviation, percentile, etc.) or various algorithms (e.g., elliptic envelope algorithm, isolation forest algorithm, one-class support vector machines algorithm, local outlier factor (LOF) algorithm, etc.) to identify outliers in a dataset. In one example embodiment, a dataset comprises one physician with 50 panels, sixty physicians with 100 panels, and one physician with 300 panels. The outlier treatment module 219 identifies 50 and 300 panels as outliers, and replaces them with an average value that works best for statistical distribution so that it is easier for the model to learn and provide better information.

The quality of a feature in a dataset has immense effect on model performance. In fact, not all features are relevant, and too many features adversely affect the model performance, e.g., as the number of features increases, it becomes difficult for the model to learn mappings between features and target. In one embodiment, the feature generation/scaling module 221 constructs new features from the existing features in a dataset to better relate to the target. In one embodiment, the feature generation/scaling module 221 selects a set of relevant attributes from large datasets, thereby making it computationally feasible to use certain machine learning and data analytic algorithms. Such selection of relevant data improves the quality and accuracy of the result. In one example embodiment, the feature generation/scaling module 221 combines existing features (e.g., a patient panel and service cost) from a dataset to create a new feature (e.g., the total cost of care). In another embodiment, feature generation/scaling module 221 utilizes scaling techniques for adjusting the values in the same range or same scale ensuring one variable is not dominated by the other, thereby creating an accurate ML algorithm.

In one embodiment, the third machine learning module 223 includes a third machine learning model 224, which is a supervised machine learning model for determining an individual burnout score for the user 102 based on personal data associated with the user 102. The personal burnout score is determined using a suitable supervised machine learning technique such as, e.g., GBM, LGMB. Xtra tree classifier, and the like. The third machine learning model 224 is supported by a correlation detection module 225, a missing value treatment module 227, an outlier treatment module 229, and a feature generation/scaling module 231 during the pre-processing and feature engineering stages, to form a master data set that gets fed into the third machine learning model 224. The functionalities of the correlation detection module 225, the missing value treatment module 227, the outlier treatment module 229, and the feature generation/scaling module 231 are similar to those of the correlation detection module 215, the missing value treatment module 217, the outlier treatment module 219, and the feature generation/scaling module 221 discussed above.

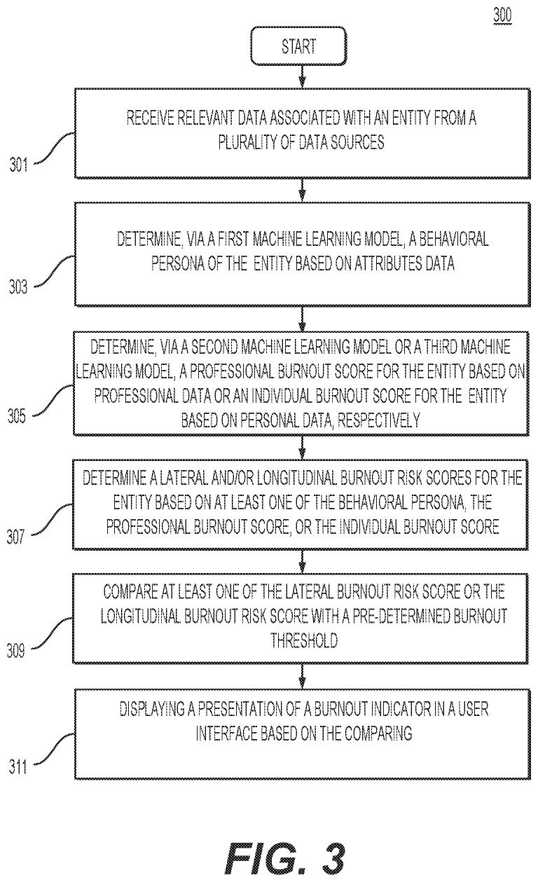

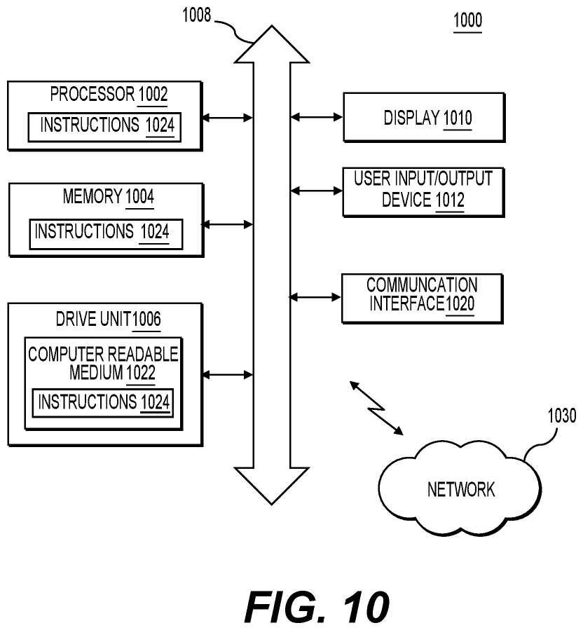

FIG. 3 is a flowchart of a process 300 for predicting a burnout of a professional entity, according to some aspects of the disclosure. In various embodiments, the burnout prediction platform 111 and/or any of the modules 201-207 performs one or more portions of the process 300 and are implemented using, for instance, a chip set including a processor and a memory as shown in FIG. 10. As such, the burnout prediction platform 111 and/or any of modules 201-207 provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 are performed in any order or combination and need not include all of the illustrated steps.

In step 301, the burnout prediction platform 111, via one or more processors 1002, receives relevant data associated with the user 102, e.g., professional entity, from a plurality of data sources, e.g., database 113. In one embodiment, the relevant data includes attributes data, professional data, and/or personal data. In one example embodiment, attributes data includes patient panel data, patient complexity data, staffing ratio data, specialty data, provider registry data, patient social determinants of health (SDOH) data, patient panel race, language, and ethnicity (RLE) data, patient volume data, or a combination thereof. In one example embodiment, professional data includes task data, clinical data, natural language processing (NLP) data, net prompter score (NPS) data, historical training data, intervention adherence data, or a combination thereof. In one example embodiment, personal data includes environmental data, social determinants of health (SDOH) data, health conditions, activity data, or a combination thereof.

In step 303, the burnout prediction platform 111, via the one or more processors 1002 and utilizing the first machine learning model 211, determines a behavioral persona of the user 102 based on the attributes data. In one embodiment, the behavior persona indicates a correlation between variables of the attributes data, and includes a low patient panel with an adequate staffing ratio for treating high-risk patients, a high patient panel with an insufficient staffing ratio for treating low-risk patients, a medium patient panel with an average staffing ratio for treating medium-risk patients, or a combination thereof. In one embodiment, the burnout prediction platform 111, via the one or more processors 1002, scales the attributes data associated with the user 102 to provide an equal weight to each variable of the attributes data. The burnout prediction platform 111, via the one or more processors 1002, inputs the scaled attributes data into the first machine learning model 211 configured to determine the behavioral persona. In one example embodiment, the first machine learning model 211 includes a deep embedded clustering algorithm, a K-means clustering algorithm, or a combination thereof. It is understood that any other type of clustering algorithm can be utilized by the first machine learning model 211. In one embodiment, the burnout prediction platform 111, via the one or more processors 1002 using an elbow method, determines an optimal number of clusters.

In step 305, the burnout prediction platform 111, via the one or more processors 1002 and utilizing the second machine learning model 214, determines a professional burnout score for the user 102 based on the professional data. In one embodiment, the professional burnout score indicates a burnout level, a stress level, or a professional burden of the user 102. In one embodiment, the burnout prediction platform 111, via the one or more processors 1002, trains the second machine learning model 214 using a professional master data set 609, after the collected professional data has been pre-processed and/or relevant features extracted. In this example embodiment, the pre-processing includes correlation detection via correlation detection module 215, missing value treatment via missing value treatment module 217, outlier treatment via outlier treatment module 219, new features creation via feature generation/scaling module 221, or a combination thereof. The burnout prediction platform 111, via the one or more processors 1002, splits the professional master data set 609 into a training professional data set and a validation professional data set. The burnout prediction platform 111, via the one or more processors 1002, inputs the training professional data set into the second machine learning model 214 to determine the professional burnout score. The performance parameters of the second machine learning model 214 are measured using the validation professional data set.

In step 305, the burnout prediction platform 111, via the one or more processors 1002 and utilizing the third machine learning model 224, determines an individual burnout score for the user 102 based on the personal data. In one embodiment, the individual burnout score indicates a burnout level, a stress level, and/or a professional burden of the user 102. In one embodiment, the burnout prediction platform 111, via the one or more processors 1002, trains the third machine learning model 224 using an individual master data set 625, after the collected personal data has been pre-processed and/or relevant features extracted. In this example embodiment, the pre-processing includes correlation detection via correlation detection module 225, missing value treatment via missing value treatment module 227, outlier treatment via outlier treatment module 229, new features creation via feature generation/scaling module 231, or a combination thereof. The burnout prediction platform 111, via the one or more processors 1002, splits the individual master data set 625 into a training individual data set and a validation individual data set. The burnout prediction platform 111, via the one or more processors 1002, inputs the training individual data set into the third machine learning model 224 to determine the individual burnout score. The performance parameters of the third machine learning model 224 are measured using the validation individual data set.

In step 307, the burnout prediction platform 111, via the one or more processors 1002, determines a lateral burnout risk score and/or a longitudinal burnout risk score for the user 102 based on at least one of the behavioral persona, the professional burnout score, or the individual burnout score. In one embodiment, the lateral burnout risk score includes a comparison between burnout risk scores associated with the user 102 and burnout risk scores associated with other professional entities in a pre-determined time period. In one embodiment, the longitudinal burnout risk score includes a comparison between multiple burnout risk scores associated with the user 102 in a pre-determined time period.

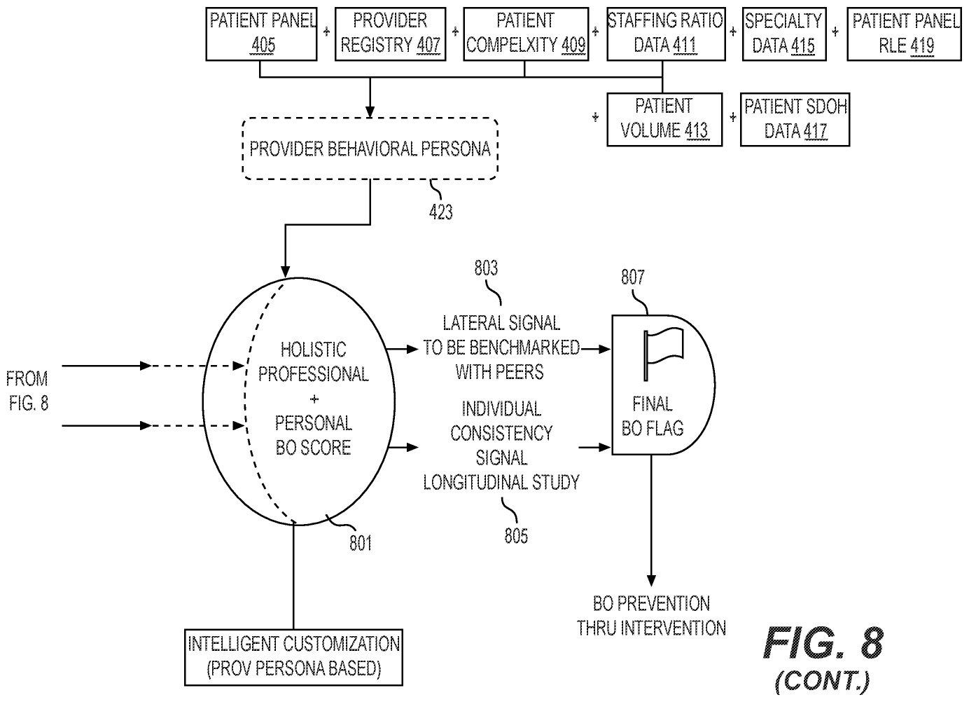

In step 309, the burnout prediction platform 111, via the one or more processors 1002, compares the lateral burnout risk score and/or the longitudinal burnout risk score with a pre-determined burnout threshold. In one embodiment, the lateral burnout risk score and/or the longitudinal burnout risk score are simply combined for comparison with the predetermined burnout threshold limit. In another embodiment, the lateral burnout risk score and/or the longitudinal burnout risk score are averaged before being compared to the pre-determined burnout threshold limit. The averaging of the lateral and/or longitudinal burnout risk scores are discussed in FIG. 8.

In step 311, the burnout prediction platform 111, via the one or more processors 1002, determines the lateral burnout risk score and/or the longitudinal burnout risk score exceeds or is equal to the pre-determined burnout threshold. The burnout prediction platform 111, via the one or more processors 1002, causes a presentation of a burnout indicator, e.g., final burnout flag 807, in the user interface of the UE 103. In one embodiment, the burnout prediction platform 111, via the one or more processors 1002, modifies the work schedule of the user 102 based on the burnout indicator, e.g., reducing the workload by delegating the work. In another embodiment, the burnout prediction platform 111, via the one or more processors 1002, generates an intervention notification based on the burnout indicator. The burnout prediction platform 111, via the one or more processors 1002, transmits the intervention notification to the UE 103 associated with the intervention entity. The burnout prediction platform 111, via the one or more processors 1002, analyzes the lateral burnout risk score and/or the longitudinal burnout risk score to measure intervention efficacy and/or intervention adherence. In a further embodiment, the burnout prediction platform 111, via the one or more processors 1002, updates the professional burnout score and/or the individual burnout score in real-time, near real-time, or on a scheduled basis to dynamically determine a burnout risk associated with the user 102.

In another embodiment, the burnout prediction platform 111, via the one or more processors 1002, determines the lateral burnout risk score and/or the longitudinal burnout risk is below the pre-determined burnout threshold. The burnout prediction platform 111, via the one or more processors 1002, causes a presentation of a burnout indicator in the user interface of the UE 103. The presentation includes recommendations to the user 102 to continue the effort to keep the burnout below the threshold level. The presentation includes queries to the user 102 asking if the user can handle additional workload, e.g., work may be transferred from other user 102 experiencing higher burnout.

The comparison of the burnout risk score(s) to the pre-determined burnout threshold can be configured in various ways. Although the examples above discuss making adjustments to the user's workload and triggering intervention measures in response to the burnout risk score(s) exceeding or being equal to the pre-determined burnout threshold, in other embodiments, the same actions may be performed in response to the burnout risk score(s) being less than or equal to the pre-determined burnout threshold. Similarly, Although the examples above discuss making recommendations to continue the effort to keep the burnout below a certain level or asking if the user can handle additional workload in response to the burnout risk score(s) being below the pre-determined burnout threshold, in other embodiments, the same actions may be performed in response to the burnout risk score(s) being greater than or equal to the pre-determined burnout threshold.

FIG. 4 is a diagram showing an example of a process for clustering similar features from a data set to generate behavioral personas of professional entities, according to some embodiments of the disclosure. In step 401, the burnout prediction platform 111 retrieves clustering features 403 (e.g., the patient panel 405, the provider registry 407, the patient complexity 409, the staffing ratio data 411, the patient volume 413, the specialty data 415, the patient SDOH data 417, and the patient panel RLE 419) from the database 113. The burnout prediction platform 111 scales the clustering features 403 by utilizing standard scaling methods to give equal weightage to the clustering features 403 to bring them on the same scale. For example, the clustering features 403 may not be on the same scale, for instance, the patient panel 405 is measured in the thousands whereas patient complexity is measured in a level of 1-5, hence the burnout prediction platform 111 brings the clustering features 403 with varying measurements under one scale for unsupervised learning.

In step 421, the burnout prediction platform 111 inputs the scaled clustering features 403 into the first machine learning model 211. As previously discussed in FIG. 2B, the first machine learning model 211 utilizes machine learning techniques or statistical unsupervised modeling techniques (e.g., K-means, deep embedded clustering, etc.) to generate the behavioral persona 423 for the user 102 by grouping the uncategorized clustering features 403. In one example embodiment, persona 1 of the behavioral persona 423 indicates that the user 102 has a low patient panel with a good staffing ratio but sees mostly high-risk patients. In another example embodiment, persona 2 of the behavioral persona 423 indicates that the user 102 has a high patient panel with a low staffing ratio but sees mostly medium to low-risk patients. In a further example embodiment, persona 3 of the behavioral persona 423 indicates that the user 102 has a medium patient panel but sees only low-risk patients. In another example embodiment, persona 4 of the behavioral persona 423 indicates that the user 102 has a low patient panel with a medium staffing ratio but sees mostly low-risk patients. The behavioral persona 423 does not produce a score, since there is no score for clustering. If the data points are homogenous, then a cluster is created, and clusters should be heterogeneous across the group, e.g., cluster 1 should be different from cluster 2.

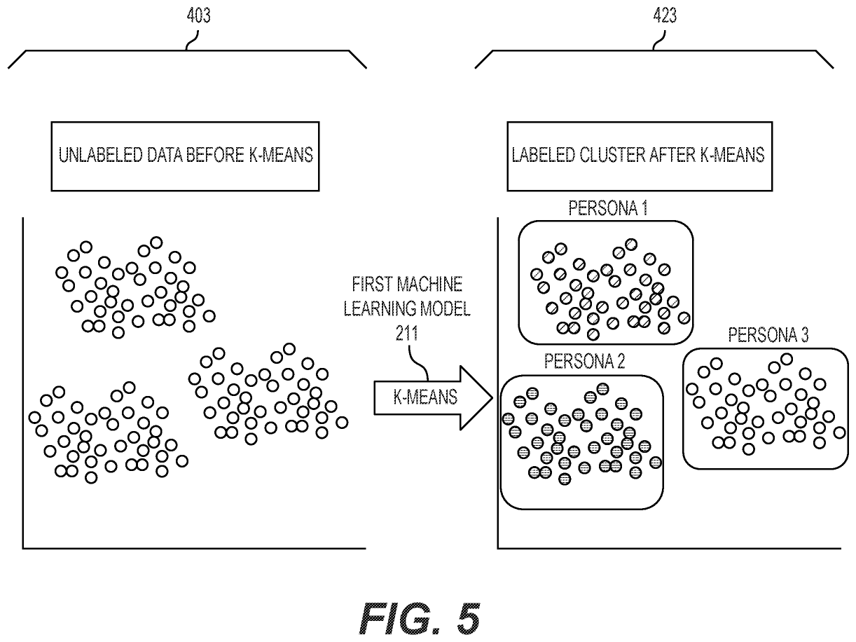

FIG. 5 is a diagram that illustrates the clustering of unlabeled data to generate behavioral personas of professional entities, according to some embodiments of the disclosure. In one embodiment, the clustering features 403 represents unlabeled data, e.g., data that have not been tagged with labels identifying characteristics, properties, or classifications. The burnout prediction platform 111 inputs the unlabeled clustering features 403 into the first machine learning model 211. In one embodiment, the first machine learning model 211 utilizes the K-means unsupervised modeling technique to label and categorize the unlabeled clustering features 403 into the behavioral personas 423. It should be understood that any other unsupervised modeling techniques may be implemented by the first machine learning model 211 to label and categorize the unlabeled clustering features 403.

In one embodiment, the burnout prediction platform 111 determines the optimal number of clusters in a data set by utilizing various cluster analysis methods, e.g., the Elbow method in which the sum of squares at each number of clusters is calculated and graphed, and a change of slope from steep to shallow (an elbow) is identified to determine the optimal number of clusters.

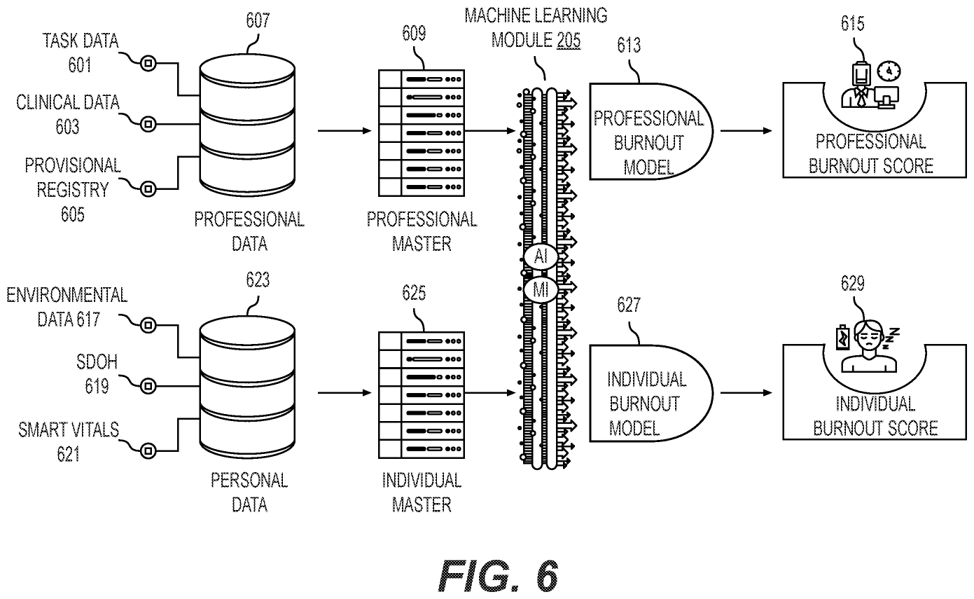

FIG. 6 is a diagram showing an example of a process for generating professional burnout scores and individual burnout scores for professional entities, according to some embodiments of the disclosure. Burnout can occur due to individual attributes and/or professional attributes. For example, the user 102 is stressed because of personal reasons (e.g., lengthy commute time to work, the vicinity he/she is staying, family responsibilities, etc.) and professional reasons (e.g., heavy workload, responsible for high-risk patients, substantial administrative work, etc.). The burnout prediction platform 111 creates individual and professional burnout models to determine the reasons for burnout for the user 102 as an individual and as a professional. The burnout prediction platform 111 differentiates professional burnout attributes from individual burnout attributes to draw a comparison for an intervention.

In one embodiment, the burnout prediction platform 111 collects professional data associated with the user 102 (e.g., task data 601, clinical data 603, provisional registry 605, etc.) from various data sources (e.g., the database 113), and stores the professional data in storage 607. The professional data in storage 607 goes through a data pre-processing pipeline (e.g., data cleaning, data integration, data reduction, data transformation, etc.) to form the professional master data set 609. The burnout prediction platform 111 splits the professional master data set 609 into a training data set and a validating data set. The burnout prediction platform 111 inputs the training data set into the second machine learning model 214 and the validation data set measures the performance (e.g., recall, precision, accuracy, area under the curve (AUC), etc.) of the second machine learning model 214. In this embodiment, the second machine learning model 214 is a supervised machine learning model that utilizes one or more supervised learning algorithms (e.g., GBM, LGBM, Xtra tree classifier, etc.) to build a professional burnout model 613 that predicts/determines professional burnout scores 615 for each professional attributes of the user 102. In one embodiment, the professional burnout model 613 generates probabilities and the probability is converted into the professional burnout scores 615.

In one embodiment, the burnout prediction platform 111 collects personal data associated with the user 102 (e.g., environmental data 617, SDOH 619, smart vital 621, etc.) from various data sources (e.g., the database 113), and stores the personal data in storage 623. The personal data in storage 623 goes through a data pre-processing pipeline (e.g., data cleaning, data integration, data reduction, data transformation, etc.) to form the individual master data set 625. The burnout prediction platform 111 splits the individual master data set 625 into a training data set and a validating data set. The burnout prediction platform 111 inputs the training data set into the third machine learning model 224 and the validation data set measures the performance (e.g., recall, precision, accuracy, area under the curve (AUC), etc.) of the third machine learning model 224. In this embodiment, the third machine learning model 224 is a supervised machine learning model that utilizes one or more supervised learning algorithms to build an individual burnout model 627 that predicts/determines individual burnout scores 629 for each personal attributes of the user 102. For example, the individual burnout model 627 generates a probability, and the probability is converted into individual burnout scores 629. The predicted professional burnout scores 615 and the individual burnout scores 629 are utilized by the intelligent customization of FIG. 8. In another embodiment, the burnout prediction platform 111 utilizes experience surveys to generate the individual burnout scores 629. For example, the user 102 is provided an experience survey that includes questions regarding the severity of the burnout experienced by the user 102. A Mini Z burnout survey may be utilized, but this survey can be replaced by any other physician engagement survey. This data set is used as the source of truth for which providers are experiencing burnout, and is also used for validating the performance of the machine learning models, e.g., the first machine learning model 211, the second machine learning model 214, the third machine learning model 224.

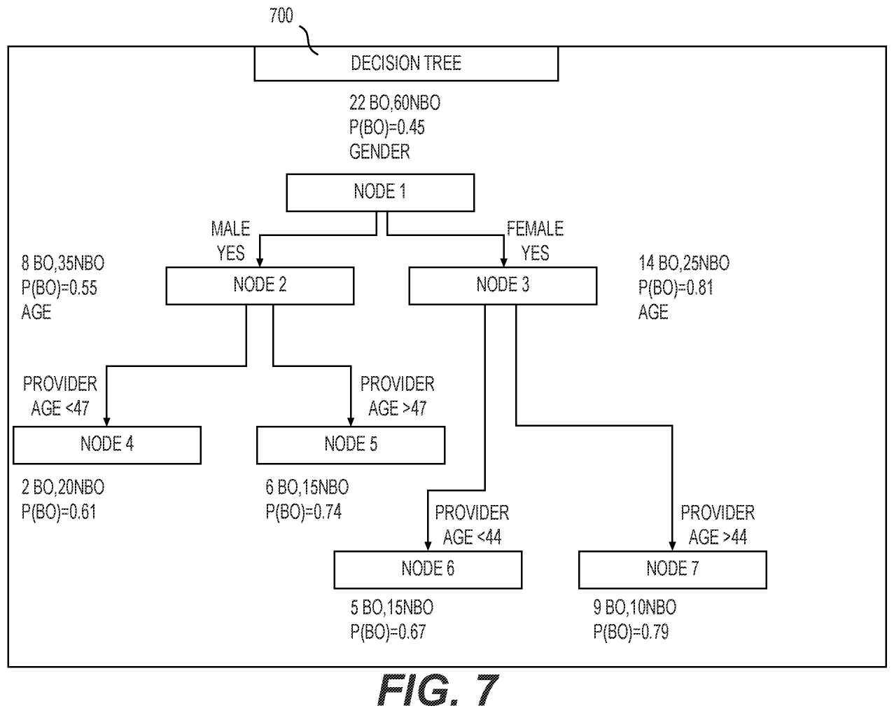

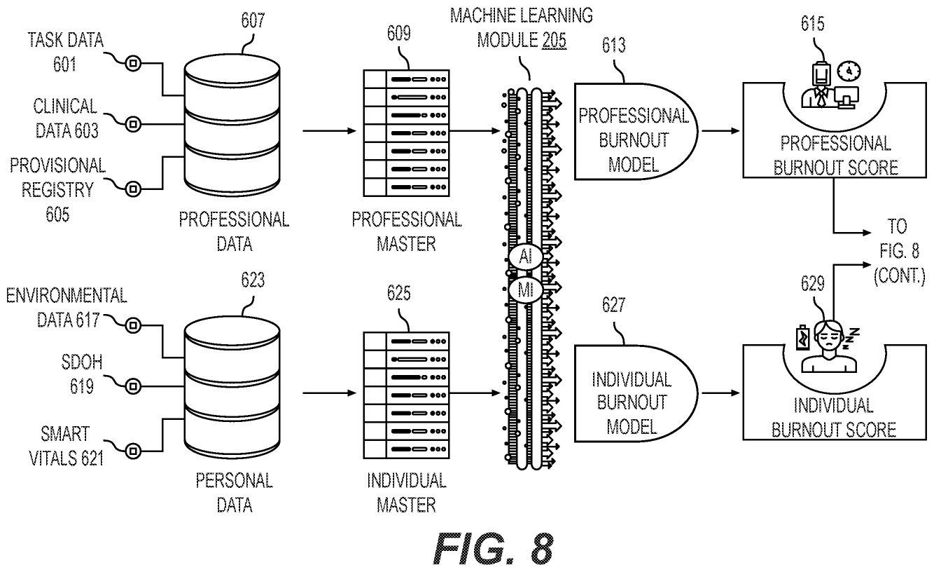

FIG. 7 is a diagram showing an example of a decision tree depicting a machine learning and artificial intelligence (AI) engine determining burnout among professional entities, according to some embodiments of the disclosure. In this example embodiment, a decision tree 700 initiates with 22 physicians experiencing burnout (BO), 60 physicians experiencing non burnout (NBO), and a BO probability of 0.45. In node 1, the decision tree 700 selects gender (male/female) as the next best attribute, whereupon two nodes are created (e.g., node 2 for male physicians and node 3 for female physicians). In node 2, the decision tree 700 determines 8 male physicians are experiencing BO, 35 male physicians are experiencing NBO, and a BO probability is 0.55. In node 3, the decision tree 700 determines 14 female physicians are experiencing BO, 25 female physicians are experiencing NBO, and a BO probability is 0.81.

In one embodiment, the decision tree 700 at nodes 2 and 3 selects age as the next best attribute, whereupon four nodes are created (e.g., nodes 4 and 5 from node 2, and nodes 6 and 7 from node 3). Node 4 indicates that amongst the male physicians below the age of 47, 2 are experiencing BO, 20 are experiencing NBO, and a BO probability is 0.61. Node 5 indicates that between the male physicians above the age of 47, 6 are experiencing BO, 15 are experiencing NBO, and a BO probability is 0.74. Node 6 specifies that among the female physicians below the age of 44, 5 are experiencing BO, 15 are experiencing NBO, and a BO probability is 0.67. Node 7 indicates that between the female physicians above the age of 44, 9 are experiencing BO, 10 are experiencing NBO, and a BO probability is 0.79. In this example embodiment, the outcome of the decision tree 700 points towards higher BO among female physicians compared to male physicians.

FIG. 8 is a diagram that illustrates a process for calculating a lateral burnout risk score and a longitudinal burnout risk score for determining an intervention, according to some embodiments of the disclosure. In one embodiment, the burnout prediction platform 111 via the machine learning module 205 combines multiple data sets to detect the risk of burnout among professional entities. These data sets pre-exist but have not been combined and utilized by the machine learning module 205. For example, the data sets include provider behavioral personas 423 (from FIG. 4), professional burnout scores 615 (from FIG. 6), and individual burnout scores 629 (from FIG. 6).

In one embodiment, the burnout prediction platform 111 performs intelligent customization 801 on the combined data sets by scoring each of the professional data and individual data. The score is then leveraged to generate a lateral burnout risk score 803 (to be benchmarked with peers) and a longitudinal burnout risk score 805 (individual consistency signal). In one embodiment, a lateral burnout risk score refers to comparing the burnout risk score with other professional entities on a certain time frame (e.g., real-time, near real-time, daily, bi-weekly, monthly, pre-scheduled basis, etc.), whereas a longitudinal burnout risk score refers to comparing the burnout risk scores of the same professional entity on a certain time frame (e.g., real-time, near real-time, for the last 12 rolling months, pre-scheduled basis, etc.) for individual tracking. The lateral burnout risk score 803 and the longitudinal burnout risk score 805 are used in tandem or as a comparison measure against which the user 102 is benchmarked for improving the quality of care, total cost of care, patient satisfaction, and provider productivity.

In one embodiment, the burnout prediction platform 111 compares the lateral burnout risk score 803 and the longitudinal burnout risk score 805 with a pre-determined burnout threshold limit. In one embodiment, the lateral and longitudinal burnout scores are simply combined for comparison with the predetermined burnout threshold limit. In another embodiment, the lateral and longitudinal burnout scores are averaged before being compared to the pre-determined burnout threshold limit. For example, the lateral burnout score is compared with overall lateral burnout scores (e.g., by taking the average of all professional scores) of a care delivery organization (CDO) or a group on a pre-scheduled basis, e.g., month-to-month. For example, a longitudinal average of the CDO or group is compared with a longitudinal burnout score on a pre-scheduled basis, e.g., the last 12 rolling months. The overall lateral burnout scores may vary from the longitudinal average. The burnout prediction platform 111 via the user interface module 207 triggers a final burnout flag 807 in a user interface of the UE 103 upon determining the lateral burnout risk score 803 and longitudinal burnout risk score 805 exceeds the pre-determined burnout threshold limit for a set period indicating the user 102 is steering towards burnout. The final burnout flag 807 is utilized for intervention by the service providers (e.g., medical directors, supervisors, or any other professionals assisting in the intervention) for a prompt intervention with the user 102 through calls, personal visitation, and so on. The final burnout flag 807 is also used as an indicator for modifying a work and/or personal schedule of the user 102, creating or modifying a meditation schedule for the user 102, recommending time-off, and reducing repeatedly done activities that may be detrimental to the user's physical and/or mental health. The final burnout flag 807 is also applied for predicting turnover of the user 102, e.g., professional entities experiencing burnout are more likely to turnover.

In another embodiment, the burnout prediction platform 111 generates a report that summarizes one or more reasons for why the professional entity may be experiencing, or may soon experience burnout, and an action plan to prevent the burnout from occurring. For example, physicians with longer commute times are given dedicated telemedicine time and the ability to work from home to prevent them from experiencing burnout caused by the long commute. For example, physicians burdened with heavy documentation are provided with tools that automate notetaking or scribes that provide transcription services to reduce burnout caused by documentation. For example, clinics or organizations are recommended to provide their clinicians with the ability to communicate with the leadership and engage the clinicians in improving clinical and non-clinical processes at the clinic to lower burnout.

As previously discussed, burnout is represented by a probability output of the machine learning module 205, which is interpreted as a likelihood for professional entities to experience burnout based on professional and/or individual attributes. The professional and/or individual attributes are relooked and/or refreshed on a scheduled basis to capture the most recent data pertaining to the user 102. The burnout prediction platform 111 captures and analyzes the lateral burnout risk score 803 and the longitudinal burnout risk score 805 for measuring intervention efficacy and professional entity adherence to reduce the burden to extend better care, quality experience, and overall provider and patient experience. As discussed, physicians experiencing healthier environments have a lower propensity to burnout. If physicians are predicted to burnout, the burnout prediction platform 111 intervenes early and processes the signal that activated the final burnout flag 807. For example, the volume of the patient and amount of documentation triggered the final burnout flag 807, whereupon the burnout prediction platform 111 focuses on these two attributes for a targeted solution. In such a manner, the burnout prediction platform 111 provides a good work-life balance among working professionals, and can be leveraged as a recruitment and retention tool. Additionally, based on the issues that are triggering the final burnout flag 807, the burnout prediction platform 111 generates recommendations to combat the issues and track their efficacy.

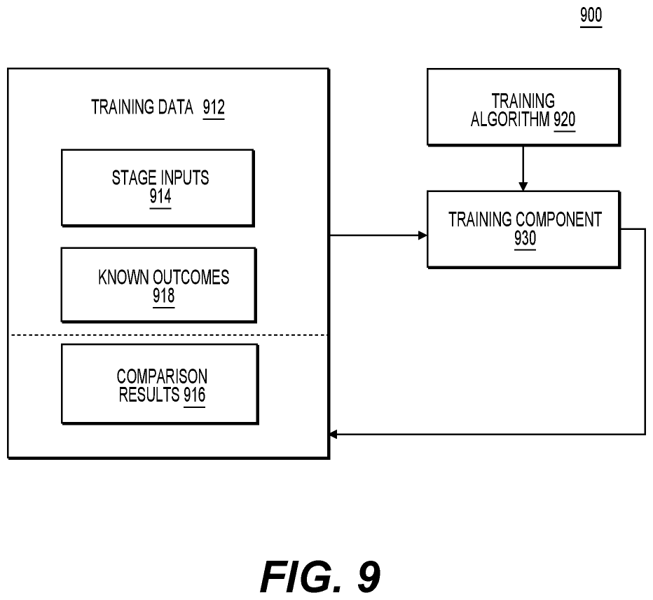

One or more implementations disclosed herein include and/or are implemented using a machine learning model, e.g., the second machine learning model 214 and the third machine learning model 224. For example, one or more of the modules of the burnout prediction platform 111 are implemented using a machine learning model and/or are used to train the machine learning model, e.g., the second machine learning model 214 and the third machine learning model 224. A given machine learning model is trained using the training flow chart 900 of FIG. 9. The training data 912 includes one or more of stage inputs 914 and the known outcomes 918 related to the machine learning model to be trained. The stage inputs 914 are from any applicable source including text, visual representations, data, values, comparisons, and stage outputs, e.g., one or more outputs from one or more steps from FIG. 3. The known outcomes 918 are included for the machine learning models generated based on supervised or semi-supervised training. An unsupervised machine learning model is not trained using the known outcomes 918. The known outcomes 918 includes known or desired outputs for future inputs similar to or in the same category as the stage inputs 914 that do not have corresponding known outputs.

The training data 912 and a training algorithm 920, e.g., one or more of the modules implemented using the machine learning model and/or are used to train the machine learning model, is provided to a training component 930 that applies the training data 912 to the training algorithm 920 to generate the machine learning model. According to an implementation, the training component 930 is provided comparison results 916 that compare a previous output of the corresponding machine learning model to apply the previous result to re-train the machine learning model. The comparison results 916 are used by the training component 930 to update the corresponding machine learning model. The training algorithm 920 utilizes machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine learning model used herein is trained and/or used by adjusting one or more weights and/or one or more layers of the machine learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

In general, any process or operation discussed in this disclosure is understood to be computer-implementable, such as the process illustrated in FIG. 3 are performed by one or more processors of a computer system as described herein. A process or process step performed by one or more processors is also referred to as an operation. The one or more processors are configured to perform such processes by having access to instructions (e.g., software or computer-readable code) that, when executed by one or more processors, cause one or more processors to perform the processes. The instructions are stored in a memory of the computer system. A processor is a central processing unit (CPU), a graphics processing unit (GPU), or any suitable type of processing unit.

A computer system, such as a system or device implementing a process or operation in the examples above, includes one or more computing devices. One or more processors of a computer system are included in a single computing device or distributed among a plurality of computing devices. One or more processors of a computer system are connected to a data storage device. A memory of the computer system includes the respective memory of each computing device of the plurality of computing devices.

FIG. 10 illustrates an implementation of a computer system that executes techniques presented herein. The computer system 1000 includes a set of instructions that are executed to cause the computer system 1000 to perform any one or more of the methods or computer based functions disclosed herein. The computer system 1000 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,” or a “server” includes one or more processors.

In a networked deployment, the computer system 1000 operates in the capacity of a server or as a client user computer in a server-client user network environment, or as a peer computer system in a peer-to-peer (or distributed) network environment. The computer system 1000 is also implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 1000 is implemented using electronic devices that provide voice, video, or data communication. Further, while the computer system 1000 is illustrated as a single system, the term “system” shall also be taken to include any collection of systems or sub-systems that individually or jointly execute a set, or multiple sets, of instructions to perform one or more computer functions.

As illustrated in FIG. 10, the computer system 1000 includes a processor 1002, e.g., a central processing unit (CPU), a graphics processing unit (GPU), or both. The processor 1002 is a component in a variety of systems. For example, the processor 1002 is part of a standard personal computer or a workstation. The processor 1002 is one or more processors, digital signal processors, application specific integrated circuits, field programmable gate arrays, servers, networks, digital circuits, analog circuits, combinations thereof, or other now known or later developed devices for analyzing and processing data. The processor 1002 implements a software program, such as code generated manually (i.e., programmed).

The computer system 1000 includes a memory 1004 that communicates via bus 1008. The memory 1004 is a main memory, a static memory, or a dynamic memory. The memory 1004 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 1004 includes a cache or random-access memory for the processor 1002. In alternative implementations, the memory 1004 is separate from the processor 1002, such as a cache memory of a processor, the system memory, or other memory. The memory 1004 is an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1004 is operable to store instructions executable by the processor 1002. The functions, acts, or tasks illustrated in the figures or described herein are performed by the processor 1002 executing the instructions stored in the memory 1004. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 1000 further includes a display 1010, such as a liquid crystal display (LCD), an organic light emitting diode (OLED), a flat panel display, a solid-state display, a cathode ray tube (CRT), a projector, a printer or other now known or later developed display device for outputting determined information. The display 1010 acts as an interface for the user to see the functioning of the processor 1002, or specifically as an interface with the software stored in the memory 1004 or in the drive unit 1006.

Additionally or alternatively, the computer system 1000 includes an input/output device 1012 configured to allow a user to interact with any of the components of the computer system 1000. The input/output device 1012 is a number pad, a keyboard, a cursor control device, such as a mouse, a joystick, touch screen display, remote control, or any other device operative to interact with the computer system 1000.

The computer system 1000 also includes the drive unit 1006 implemented as a disk or optical drive. The drive unit 1006 includes a computer-readable medium 1022 in which one or more sets of instructions 1024, e.g. software, is embedded. Further, the sets of instructions 1024 embodies one or more of the methods or logic as described herein. The sets of instructions 1024 resides completely or partially within the memory 1004 and/or within the processor 1002 during execution by the computer system 1000. The memory 1004 and the processor 1002 also include computer-readable media as discussed above.

In some systems, computer-readable medium 1022 includes the set of instructions 1024 or receives and executes the set of instructions 1024 responsive to a propagated signal so that a device connected to network 1030 communicates voice, video, audio, images, or any other data over the network 1030. Further, the sets of instructions 1024 are transmitted or received over the network 1030 via the communication port or interface 1020, and/or using the bus 1008. The communication port or interface 1020 is a part of the processor 1002 or is a separate component. The communication port or interface 1020 is created in software or is a physical connection in hardware. The communication port or interface 1020 is configured to connect with the network 1030, external media, the display 1010, or any other components in the computer system 1000, or combinations thereof. The connection with the network 1030 is a physical connection, such as a wired Ethernet connection, or is established wirelessly as discussed below. Likewise, the additional connections with other components of the computer system 1000 are physical connections or are established wirelessly. The network 1030 alternatively be directly connected to the bus 1008.

While the computer-readable medium 1022 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 1022 is non-transitory, and may be tangible.

The computer-readable medium 1022 includes a solid-state memory such as a memory card or other package that houses one or more non-volatile read-only memories. The computer-readable medium 1022 is a random-access memory or other volatile re-writable memory. Additionally or alternatively, the computer-readable medium 1022 includes a magneto-optical or optical medium, such as a disk or tapes or other storage device to capture carrier wave signals such as a signal communicated over a transmission medium. A digital file attachment to an e-mail or other self-contained information archive or set of archives is considered a distribution medium that is a tangible storage medium. Accordingly, the disclosure is considered to include any one or more of a computer-readable medium or a distribution medium and other equivalents and successor media, in which data or instructions are stored.

In an alternative implementation, dedicated hardware implementations, such as application specific integrated circuits, programmable logic arrays, and other hardware devices, is constructed to implement one or more of the methods described herein. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Computer system 1000 is connected to the network 1030. The network 1030 defines one or more networks including wired or wireless networks. The wireless network is a cellular telephone network, an 802.10, 802.16, 802.20, or WiMAX network. Further, such networks include a public network, such as the Internet, a private network, such as an intranet, or combinations thereof, and utilizes a variety of networking protocols now available or later developed including, but not limited to TCP/IP based networking protocols. The network 1030 includes wide area networks (WAN), such as the Internet, local area networks (LAN), campus area networks, metropolitan area networks, a direct connection such as through a Universal Serial Bus (USB) port, or any other networks that allows for data communication. The network 1030 is configured to couple one computing device to another computing device to enable communication of data between the devices. The network 1030 is generally enabled to employ any form of machine-readable media for communicating information from one device to another. The network 1030 includes communication methods by which information travels between computing devices. The network 1030 is divided into sub-networks. The sub-networks allow access to all of the other components connected thereto or the sub-networks restrict access between the components. The network 1030 is regarded as a public or private network connection and includes, for example, a virtual private network or an encryption or other security mechanism employed over the public Internet, or the like.

In accordance with various implementations of the present disclosure, the methods described herein are implemented by software programs executable by a computer system. Further, in an example, non-limited implementation, implementations can include distributed processing, component/object distributed processing, and parallel processing. Alternatively, virtual computer system processing can be constructed to implement one or more of the methods or functionality as described herein.

Although the present specification describes components and functions that are implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure is implemented using any appropriate techniques for implementing the functionality described herein. The disclosure is not limited to any particular programming language or operating system.

It should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention are practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications are made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

The present disclosure furthermore relates to the following aspects.

Example 1. A computer-implemented method for predicting a burnout of an entity, the method comprising: receiving, by one or more processors, relevant data associated with the entity from a plurality of data sources, wherein the relevant data includes attributes data and at least one of professional data or personal data; determining, by the one or more processors and using a first machine learning model, a behavioral persona of the entity based on the attributes data; determining, by the one or more processors and using at least one of a second machine learning model or a third machine learning model, at least one of a professional burnout score for the entity based on the professional data or an individual burnout score for the entity based on the personal data, respectively; determining, by the one or more processors, at least one of a lateral burnout risk score or a longitudinal burnout risk score for the entity based on at least one of the behavioral persona, the professional burnout score, or the individual burnout score; comparing, by the one or more processors, at least one of the lateral burnout risk score or the longitudinal burnout risk score with a pre-determined burnout threshold; and causing, by the one or more processors, a presentation of a burnout indicator to be displayed in a user interface of a device based upon the comparing.

Example 2. The computer-implemented method of example 1, wherein determining the behavioral persona comprises: scaling, by the one or more processors, the attributes data associated with the entity to provide an equal weight to each variable of the attributes data; and inputting, by the one or more processors, the scaled attributes data into the first machine learning model configured to determine the behavioral persona, wherein the first machine learning model comprises at least one of a deep embedded clustering algorithm or a K-means clustering algorithm.

Example 3. The computer-implemented method of any of the preceding examples, wherein the second machine learning model is trained by: pre-processing, by the one or more processors, the professional data to generate a professional master data set, wherein the pre-processing includes at least one of correlation detection, missing value treatment, outlier treatment, new features creation, or scaling; splitting, by the one or more processors, the professional master data set into a training professional data set and a validation professional data set; and inputting, by the one or more processors, the training professional data set into the second machine learning model to determine the professional burnout score, wherein one or more performance parameters of the second machine learning model are measured using the validation professional data set.

Example 4. The computer-implemented method of any of the preceding examples, wherein the third machine learning model is trained by: pre-processing, by the one or more processors, the personal data to generate an individual master data set, wherein the pre-processing includes at least one of correlation detection, missing value treatment, outlier treatment, new features creation, or scaling; splitting, by the one or more processors, the individual master data set into a training individual data set and a validation individual data set; and inputting, by the one or more processors, the training individual data set into the third machine learning model to determine the individual burnout score, wherein one or more performance parameters of the third machine learning model are measured using the validation individual data set.

Example 5. The computer-implemented method of any of the preceding examples, further comprising: modifying, by the one or more processors, a work schedule of the entity based on the burnout indicator; generating, by the one or more processors, an intervention notification; and transmitting, by the one or more processors, the intervention notification to a device associated with an intervention entity.

Example 6. The computer-implemented method of example 5, further comprising: analyzing, by the one or more processors, the lateral burnout risk score and/or the longitudinal burnout risk score to measure intervention efficacy and/or intervention adherence.

Example 7. The computer-implemented method of any of the preceding examples, wherein the attributes data includes at least one of patient panel data, patient complexity data, staffing ratio data, specialty data, provider registry data, patient social determinants of health (SDOH) data, patient panel race, language, and ethnicity (RLE) data, or patient volume data.

Example 8. The computer-implemented method of any of the preceding examples, wherein the professional data includes at least one of task data, clinical data, natural language processing (NLP) data, net prompter score (NPS) data, historical training data, or intervention adherence data.

Example 9. The computer-implemented method of any of the preceding examples, wherein the personal data includes at least one of environmental data, social determinants of health (SDOH) data, health condition, or activity data.

Example 10. The computer-implemented method of any of the preceding examples, wherein the lateral burnout risk score includes a comparison between one or more burnout risk scores associated with the entity and one or more burnout risk scores associated with other professional entities in a pre-determined time period.

Example 11. The computer-implemented method of any of the preceding examples, wherein the longitudinal burnout risk score includes a comparison between multiple burnout risk scores associated with the entity in a pre-determined time period.

Example 12. The computer-implemented method of any of the preceding examples, wherein the behavioral persona of the entity indicates a correlation between variables of the attributes data, and wherein the behavioral persona includes a low patient panel with an adequate staffing ratio for treating high-risk patients, a high patient panel with an insufficient staffing ratio for treating low-risk patients, or a medium patient panel with an average staffing ratio for treating medium-risk patients.

Example 13. The computer-implemented method of any of the preceding examples, wherein each of the professional burnout score and the individual burnout score indicates at least one of a burnout level, a stress level, or a professional burden.

Example 14. computer-implemented method of example 2, wherein determining the behavioral persona further comprises: determining, by the one or more processors and using an elbow method, an optimal number of clusters.

Example 15. The computer-implemented method of any of the preceding examples, further comprising: updating, by the one or more processors, the professional burnout score and/or the individual burnout score in real-time, near real-time, or on a scheduled basis to dynamically determine a burnout risk associated with the entity.

Example 16. A system for predicting a burnout of an entity, comprising: one or more processors; and at least one non-transitory computer readable medium storing instructions which, when executed by the one or more processors, cause the one or more processors to perform operations comprising: receiving relevant data associated with the entity from a plurality of data sources, wherein the relevant data includes attributes data and at least one of professional data or personal data; determining, using a first machine learning model, a behavioral persona of the entity based on the attributes data; determining, using at least one of a second machine learning model or a third machine learning model, at least one of a professional burnout score for the entity based on the professional data or an individual burnout score for the entity based on the personal data, respectively; determining at least one of a lateral burnout risk score or a longitudinal burnout risk score for the entity based on at least one of the behavioral persona, the professional burnout score, or the individual burnout score; comparing at least one of the lateral burnout risk score or the longitudinal burnout risk score with a pre-determined burnout threshold; and causing a presentation of a burnout indicator to be displayed in a user interface of a device based upon the comparing.

Example 17. The system of example 16, wherein determining the behavioral persona comprises: scaling the attributes data associated with the entity to provide an equal weight to each variable of the attributes data; and inputting the scaled attributes data into the first machine learning model configured to determine the behavioral persona, wherein the first machine learning model comprises at least one of a deep embedded clustering algorithm or a K-means clustering algorithm.

Example 18. The system of any of Examples 16-17, wherein the second machine learning model is trained by: pre-processing the professional data to generate a professional master data set, wherein the pre-processing includes at least one of correlation detection, missing value treatment, outlier treatment, new features creation, or scaling; splitting the professional master data set into a training professional data set and a validation professional data set; and inputting the training professional data set into the second machine learning model to determine the professional burnout score, wherein one or more performance parameters of the second machine learning model are measured using the validation professional data set.

Example 19. The system of any of Examples 16-19, wherein the third machine learning model is trained by: pre-processing the personal data to generate an individual master data set, wherein the pre-processing includes at least one of correlation detection, missing value treatment, outlier treatment, new features creation, or scaling; splitting the individual master data set into a training individual data set and a validation individual data set; and inputting the training individual data set into the third machine learning model to determine the individual burnout score, wherein one or more performance parameters of the third machine learning model are measured using the validation individual data set.

Example 20. A non-transitory computer readable medium for predicting a burnout of an entity, the non-transitory computer readable medium storing instructions which, when executed by one or more processors, cause the one or more processors to perform operations comprising: receiving relevant data associated with the entity from a plurality of data sources, wherein the relevant data includes attributes data and at least one of professional data or personal data; determining, using a first machine learning model, a behavioral persona of the entity based on the attributes data; determining, using at least one of a second machine learning model or a third machine learning model, at least one of a professional burnout score for the entity based on the professional data or an individual burnout score for the entity based on the personal data, respectively; determining at least one of a lateral burnout risk score or a longitudinal burnout risk score for the entity based on at least one of the behavioral persona, the professional burnout score, or the individual burnout score; comparing at least one of the lateral burnout risk score or the longitudinal burnout risk score with a pre-determined burnout threshold; and causing a presentation of a burnout indicator to be displayed in a user interface of a device based upon the comparing.

What is claimed is:

1. A computer-implemented method for predicting burnout of an entity, the method comprising:
receiving, by one or more processors, relevant data associated with the entity from a plurality of data sources, wherein the relevant data includes attributes data and at least one of professional data or personal data;
determining, by the one or more processors and using a first machine learning model, a behavioral persona of the entity based on the attributes data;
determining, by the one or more processors and using at least one of a second machine learning model or a third machine learning model, at least one of a professional burnout score for the entity based on the professional data or an individual burnout score for the entity based on the personal data, respectively;
determining, by the one or more processors, at least one of a lateral burnout risk score or a longitudinal burnout risk score for the entity based on at least one of the behavioral persona, the professional burnout score, or the individual burnout score;
comparing, by the one or more processors, at least one of the lateral burnout risk score or the longitudinal burnout risk score with a pre-determined burnout threshold; and
causing, by the one or more processors, a presentation of a burnout indicator to be displayed in a user interface of a device based upon the comparing.

2. The computer-implemented method of claim 1, wherein determining the behavioral persona comprises:
scaling, by the one or more processors, the attributes data associated with the entity to provide an equal weight to each variable of the attributes data; and
inputting, by the one or more processors, the scaled attributes data into the first machine learning model configured to determine the behavioral persona, wherein the first machine learning model comprises at least one of a deep embedded clustering algorithm or a K-means clustering algorithm.

3. The computer-implemented method of claim 1, wherein the second machine learning model is trained by:
pre-processing, by the one or more processors, the professional data to generate a professional master data set, wherein the pre-processing includes at least one of correlation detection, missing value treatment, outlier treatment, new features creation, or scaling;
splitting, by the one or more processors, the professional master data set into a training professional data set and a validation professional data set; and
inputting, by the one or more processors, the training professional data set into the second machine learning model to determine the professional burnout score, wherein one or more performance parameters of the second machine learning model are measured using the validation professional data set.

4. The computer-implemented method of claim 1, wherein the third machine learning model is trained by:
pre-processing, by the one or more processors, the personal data to generate an individual master data set, wherein the pre-processing includes at least one of correlation detection, missing value treatment, outlier treatment, new features creation, or scaling;
splitting, by the one or more processors, the individual master data set into a training individual data set and a validation individual data set; and
inputting, by the one or more processors, the training individual data set into the third machine learning model to determine the individual burnout score, wherein one or more performance parameters of the third machine learning model are measured using the validation individual data set.

5. The computer-implemented method of claim 1, further comprising:
modifying, by the one or more processors, a work schedule of the entity based on the burnout indicator;
generating, by the one or more processors, an intervention notification; and
transmitting, by the one or more processors, the intervention notification to a device associated with an intervention entity.

6. The computer-implemented method of claim 5, further comprising:
analyzing, by the one or more processors, the lateral burnout risk score and/or the longitudinal burnout risk score to measure intervention efficacy and/or intervention adherence.

7. The computer-implemented method of claim 1, wherein the attributes data includes at least one of patient panel data, patient complexity data, staffing ratio data, specialty data, provider registry data, patient social determinants of health (SDOH) data, patient panel race, language, and ethnicity (RLE) data, or patient volume data.

8. The computer-implemented method of claim 1, wherein the professional data includes at least one of task data, clinical data, natural language processing (NLP) data, net prompter score (NPS) data, historical training data, or intervention adherence data.

9. The computer-implemented method of claim 1, wherein the personal data includes at least one of environmental data, social determinants of health (SDOH) data, health condition, or activity data.

10. The computer-implemented method of claim 1, wherein the lateral burnout risk score includes a comparison between one or more burnout risk scores associated with the entity and one or more burnout risk scores associated with other professional entities in a pre-determined time period.

11. The computer-implemented method of claim 1, wherein the longitudinal burnout risk score includes a comparison between multiple burnout risk scores associated with the entity in a pre-determined time period.

12. The computer-implemented method of claim 1, wherein the behavioral persona of the entity indicates a correlation between variables of the attributes data, and wherein the behavioral persona includes a low patient panel with an adequate staffing ratio for treating high-risk patients, a high patient panel with an insufficient staffing ratio for treating low-risk patients, or a medium patient panel with an average staffing ratio for treating medium-risk patients.

13. The computer-implemented method of claim 1, wherein each of the professional burnout score and the individual burnout score indicates at least one of a burnout level, a stress level, or a professional burden.

14. The computer-implemented method of claim 2, wherein determining the behavioral persona further comprises:
determining, by the one or more processors and using an elbow method, an optimal number of clusters.

15. The computer-implemented method of claim 1, further comprising:
updating, by the one or more processors, the professional burnout score and/or the individual burnout score in real-time, near real-time, or on a scheduled basis to dynamically determine a burnout risk associated with the entity.

16. A system for predicting a burnout of an entity, comprising:
one or more processors; and
at least one non-transitory computer readable medium storing instructions which, when executed by the one or more processors, cause the one or more processors to perform operations comprising:
receiving relevant data associated with the entity from a plurality of data sources, wherein the relevant data includes attributes data and at least one of professional data or personal data;
determining, using a first machine learning model, a behavioral persona of the entity based on the attributes data;
determining, using at least one of a second machine learning model or a third machine learning model, at least one of a professional burnout score for the entity based on the professional data or an individual burnout score for the entity based on the personal data, respectively;
determining at least one of a lateral burnout risk score or a longitudinal burnout risk score for the entity based on at least one of the behavioral persona, the professional burnout score, or the individual burnout score;
comparing at least one of the lateral burnout risk score or the longitudinal burnout risk score with a pre-determined burnout threshold; and
causing a presentation of a burnout indicator to be displayed in a user interface of a device based upon the comparing.

17. The system of claim 16, wherein determining the behavioral persona comprises:
scaling the attributes data associated with the entity to provide an equal weight to each variable of the attributes data; and
inputting the scaled attributes data into the first machine learning model configured to determine the behavioral persona, wherein the first machine learning model comprises at least one of a deep embedded clustering algorithm or a K-means clustering algorithm.

18. The system of claim 16, wherein the second machine learning model is trained by:
pre-processing the professional data to generate a professional master data set, wherein the pre-processing includes at least one of correlation detection, missing value treatment, outlier treatment, new features creation, or scaling;
splitting the professional master data set into a training professional data set and a validation professional data set; and
inputting the training professional data set into the second machine learning model to determine the professional burnout score, wherein one or more performance parameters of the second machine learning model are measured using the validation professional data set.

19. The system of claim 16, wherein the third machine learning model is trained by:
pre-processing the personal data to generate an individual master data set, wherein the pre-processing includes at least one of correlation detection, missing value treatment, outlier treatment, new features creation, or scaling;
splitting the individual master data set into a training individual data set and a validation individual data set; and
inputting the training individual data set into the third machine learning model to determine the individual burnout score, wherein one or more performance parameters of the third machine learning model are measured using the validation individual data set.

20. A non-transitory computer readable medium for predicting a burnout of an entity, the non-transitory computer readable medium storing instructions which, when executed by one or more processors, cause the one or more processors to perform operations comprising:
receiving relevant data associated with the entity from a plurality of data sources, wherein the relevant data includes attributes data and at least one of professional data or personal data;
determining, using a first machine learning model, a behavioral persona of the entity based on the attributes data;
determining, using at least one of a second machine learning model or a third machine learning model, at least one of a professional burnout score for the entity based on the professional data or an individual burnout score for the entity based on the personal data, respectively;
determining at least one of a lateral burnout risk score or a longitudinal burnout risk score for the entity based on at least one of the behavioral persona, the professional burnout score, or the individual burnout score;
comparing at least one of the lateral burnout risk score or the longitudinal burnout risk score with a pre-determined burnout threshold; and
causing a presentation of a burnout indicator to be displayed in a user interface of a device based upon the comparing.
